(19) United States
(12) Patent Application Publication
(10) Pub. No.: US 2025/0138694 A1
(43) Pub. Date: May 1, 2025

(54) MULTI-DEVICE MOUSE CONTROL METHOD AND APPARATUS, DEVICE, AND MEDIUM

(71) Applicant: Beijing Zitiao Network Technology Co., Ltd., Beijing (CN)

(72) Inventor: Peng LI, Beijing (CN)

(21) Appl. No.: 18/933,308

(22) Filed: Oct. 31, 2024

(30) Foreign Application Priority Data
Oct. 31, 2023 (CN) 2023114364591

(51) Int. Cl. G06F 3/04812; G06F 3/01; G06F 3/0354

(52) U.S. Cl. CPC G06F 3/04812; G06F 3/011; G06F 3/03543

(57) ABSTRACT

Embodiments of the present disclosure relate to a multi-device mouse control method and apparatus, a device, and a medium. The method is applied to a first device based on a virtual reality technology, and includes: displaying a plurality of device screens of a plurality of second devices on a virtual panel; determining, in response to a movement of a mouse, a first movement location of a first mouse pointer on the virtual panel, where the mouse is connected with the first device; determining an intersection detection result between the first movement location and the plurality of device screens; and performing movement control on the first mouse pointer and/or a plurality of second mouse pointers of the plurality of second devices based on the intersection detection result, where the first mouse pointer and the second mouse pointers are mutually exclusive in display.

### CROSS-REFERENCE TO RELATED APPLICATION(S)

This application claims priority to Chinese Application No. 202311436459.1 filed Oct. 31, 2023, the disclosure of which is incorporated herein by reference in its entity.

### FIELD

The present disclosure relates to the field of computer technology, and in particular to a multi-device mouse control method and apparatus, a device, and a medium.

### BACKGROUND

When a device of virtual reality (VR) technology, such as a VR head mounted display is used, contents of a computer, a tablet, and other devices may be displayed in a virtual space. In the related art, on the basis of displaying contents of other devices on the VR device such as the head mounted display, it is necessary to respectively use mice connected to the other devices to operate the other devices, which is low in operation efficiency and complex in process.

### SUMMARY

In order to solve the above technical problems, the present disclosure provides a multi-device mouse control method.

An embodiment of the present disclosure provides a multi-device mouse control method. The method is applied to a first device based on a virtual reality technology, and includes:
displaying a plurality of device screens of a plurality of second devices on a virtual panel;
determining, in response to a movement of a mouse, a first movement location of a first mouse pointer on the virtual panel, where the mouse is connected with the first device;
determining an intersection detection result between the first movement location and the plurality of device screens; and
performing movement control on the first mouse pointer and/or a plurality of second mouse pointers of the plurality of second devices based on the intersection detection result, where the first mouse pointer and the second mouse pointers are mutually exclusive in display.

An embodiment of the present disclosure further provides a multi-device mouse control apparatus. The apparatus is arranged on a first device based on a virtual reality technology, and includes:
a display module, configured to display a plurality of device screens of a plurality of second devices on a virtual panel;
a first movement module, configured to determine, in response to a movement of a mouse, a first movement location of a first mouse pointer on the virtual panel, where the mouse is connected with the first device;
a detection module, configured to determine an intersection detection result between the first movement location and the plurality of device screens; and
a second movement module, configured to perform movement control on the first mouse pointer and/or a plurality of second mouse pointers of the plurality of second devices based on the intersection detection result, where the first mouse pointer and the second mouse pointers are mutually exclusive in display.

An embodiment of the present disclosure further provides an electronic device. The electronic device includes: a processor; and a memory used to store executable instructions of the processor. The processor is used to read the executable instructions from the memory and execute the instructions to implement the multi-device mouse control method provided by this embodiment of the present disclosure.

An embodiment of the present disclosure further provides a computer-readable storage medium. The storage medium stores a computer program. The computer program is used to perform the multi-device mouse control method provided by this embodiment of the present disclosure.

Compared with the prior art, the technical solution provided by this embodiment of the present disclosure has the following advantages: according to the multi-device mouse control solution provided by this embodiment of the present disclosure, the first device based on the virtual reality technology displays the plurality of device screens of the plurality of second devices on the virtual panel; in response to the movement of the mouse, the first movement location of the first mouse pointer on the virtual panel is determined, where the mouse is connected with the first device; the intersection detection result between the first movement location and the plurality of device screens is determined; and the movement control is performed on the first mouse pointer and/or the plurality of second mouse pointers of the plurality of second devices based on the intersection detection result, where the first mouse pointer and the second mouse pointers are mutually exclusive in display. By adopting the above technical solution, on the basis of displaying the plurality of device screens of the plurality of second devices on the virtual panel of the first device, the first movement location of the first mouse pointer on the virtual panel may be determined when the mouse moves, and the movement control is performed on the first mouse pointer and/or the second mouse pointers of the plurality of second devices based on the intersection detection result between the first movement location and the plurality of device screens; and based on the intersection detection on the mouse movement location and the plurality of device screens, as well as the mutually exclusive display setting of the mouse pointers of the first device and the other devices, the first device and the plurality of second devices displaying the device screens in the first device may be rapidly operated with one mouse, thereby avoiding the operation of the plurality of mice, and improving operation efficiency.

### BRIEF DESCRIPTION OF THE DRAWINGS

The above and other features, advantages, and aspects of various embodiments of the present disclosure will become more apparent in conjunction with the accompanying drawings and with reference to following specific implementations. Throughout the accompanying drawings, the same or similar reference numerals denote the same or similar elements. It should be understood that the accompanying drawings are illustrative, and components and elements may not necessarily be drawn to scale.

FIG. 1 is a schematic flowchart of a multi-device mouse control method according to an embodiment of the present disclosure;

FIG. 2 is a schematic diagram of a multi-device connection according to an embodiment of the present disclosure;

FIG. 3 is a schematic flowchart of another multi-device mouse control method according to an embodiment of the present disclosure;

FIG. 4 is a schematic diagram of a multi-device mouse control according to an embodiment of the present disclosure;

FIG. 5 is a schematic flowchart of yet another multi-device mouse control method according to an embodiment of the present disclosure;

FIG. 6 is a structural schematic diagram of a multi-device mouse control apparatus according to an embodiment of the present disclosure; and

FIG. 7 is a structural schematic diagram of an electronic device according to an embodiment of the present disclosure.

### DETAILED DESCRIPTION OF EMBODIMENTS

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

It should be understood that the steps recorded in the method implementations in the present disclosure may be performed in different orders and/or in parallel. Further, additional steps may be included and/or the execution of the illustrated steps may be omitted in the method implementations. The scope of the present disclosure is not limited in this aspect.

The term “including” used herein and variations thereof are open-ended inclusions, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the order or relation of interdependence of functions performed by these apparatuses, modules, or units.

It should be noted that modifications of “a” and “a plurality of” mentioned in the present disclosure are indicative rather than limiting, and those skilled in the art should understand that unless otherwise explicitly specified in the context, it should be interpreted as “one or more”.

The names of messages or information exchanged between a plurality of apparatuses in the implementations of the present disclosure are provided for illustrative purposes only, and are not used to limit the scope of these messages or information.

When a VR device is used, a content of a virtual space and a real world are two separate parts, and other devices in the real world cannot be directly displayed in the virtual space. In the related art, contents of the other devices may be displayed in the virtual space through technical means. However, operating the contents of the other devices still requires the use of mice connected to the other devices. If the plurality of other devices need to be respectively operated by using the mice connected to the other devices, operation efficiency is low, and the process is complex.

An embodiment of the present disclosure provides a multi-device mouse control method. The method is introduced below in conjunction with specific embodiments.

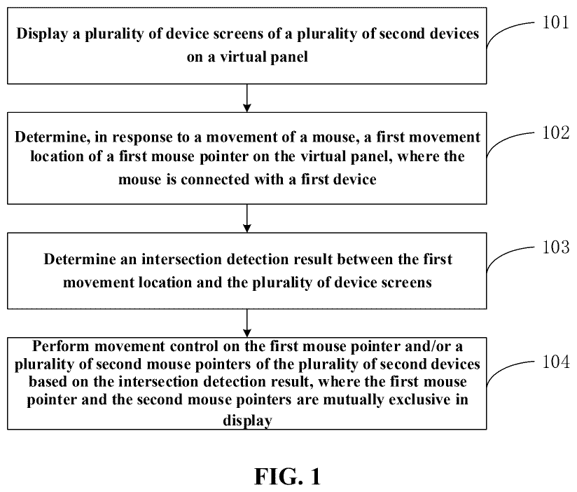

FIG. 1 is a schematic flowchart of a multi-device mouse control method according to an embodiment of the present disclosure. The method may be performed by a multi-device mouse control apparatus. The apparatus may be implemented by software and/or hardware, and may be typically integrated in an electronic device. As shown in FIG. 1, the method is applied to a first device based on a virtual reality technology, and includes:

Step 101: Display a plurality of device screens of a plurality of second devices on a virtual panel.

The first device may be a device based on the VR technology, that is, a virtual world may be created through the first device, and a user may immerse in the virtual world and interact with scenarios, objects, virtual characters, etc. therein. In this embodiment of the present disclosure, the first device may be a virtual reality head mounted display (HMD), such as an all-in-one VR headset, a phone VR headset, and an external VR headset, which is not specifically limited. The second device may be a device connected to the first device. For example, the second device may be a desktop computer, a laptop, a television, a tablet, a mobile phone, etc. This embodiment of the present disclosure does not limit an operating system of the second device, which may include, for example, Android, Windows, Linux, MacOS, and other operating systems. The virtual panel may be a panel created by the first device for other devices to display contents, and a device screen of each second device may be displayed on the virtual panel.

In this embodiment of the present disclosure, the displaying a plurality of device screens of a plurality of second devices on a virtual panel may include: creating a virtual panel in a virtual space through a screen manager; and displaying the plurality of device screens of the plurality of second devices on the virtual panel through a streaming technology or a screen casting technology.

The screen manager may be a functional module of a remote screen proxy in the first device, through which the virtual panel may be created. The streaming technology may be a technology for real-time compression and transmission of multimedia over the network. The screen casting technology may involve projecting a file, a video, or audio from one device to another device for display, such as projecting a file from a mobile phone to a computer for display.

The first device may create the virtual panel in the virtual space through the screen manager and use the streaming technology or the screen casting technology to display the device screen of each second device on the virtual panel, where the plurality of device screens may be displayed on the virtual panel.

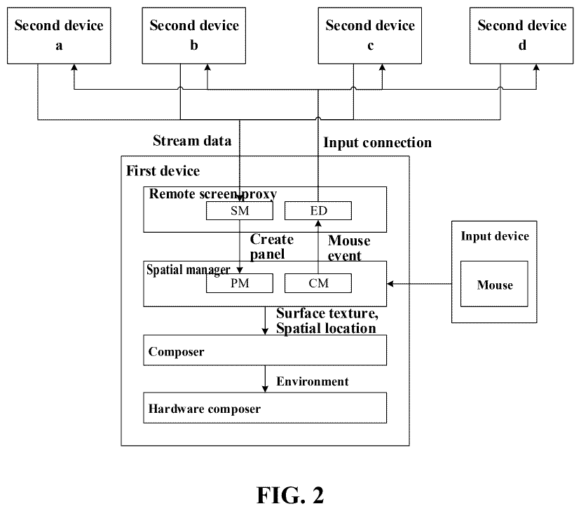

Exemplarily, FIG. 2 is a schematic diagram of a multi-device connection according to an embodiment of the present disclosure. As shown in FIG. 2, with the first device being a VR headset and 4 second devices being included in the figure as an example, the first device is connected with the 4 second devices through Bluetooth or WIFI. Each second device sends, through the streaming technology or the screen casting technology, a device screen to the first device through a Bluetooth or WIFI data link. Stream data (Stream) in the figure may be the device screen of each second device. The screen manager (SM) of the remote screen proxy in the first device may create a virtual panel (Create Panel), a panel manager (PM) in a spatial manager may set locations of the plurality of device screens in the virtual panel, and send surface texture, spatial locations, etc. to a composer for composition, where the surface texture may be a captured frame from the stream data, namely the device screen, and the spatial locations may include a location of the virtual panel and a location of each device screen on the virtual panel. The composer adds an environment (present) and sends the environment to a hardware composer (HWC) for composition and display on a screen of the first device. In this case, the plurality of device screens of the plurality of second devices are displayed in the virtual space of the VR headset.

Step 102: Determine, in response to a movement of a mouse, a first movement location of a first mouse pointer on the virtual panel, where the mouse is connected with the first device.

The mouse may be a mouse connected with the first device. A specific connection method is not limited, and may include, for example, Bluetooth, WIFI, USB, or the like. In this embodiment of the present disclosure, operation control over the first device and the plurality of second devices is achieved through the mouse connected with the first device. The first mouse pointer may be a simulated mouse pointer in the first device. The first mouse pointer may move along with the mouse within the virtual panel in the virtual space. In this embodiment of the present disclosure, the first mouse pointer is controlled to move only within the virtual panel. The first movement location may refer to location changes of the first mouse pointer in the process of moving along with the mouse, and may include coordinates of a plurality of movement points in a movement trajectory obtained by converting an actual movement trajectory of the mouse onto the virtual panel. Each movement point is a trajectory point. That is, the first movement location may include the plurality of movement point coordinates.

Specifically, after the mouse is controlled by the user to move, a movement event may be reported to the spatial manager in a first event. The first device may determine, through the spatial manager, a first movement location of the first mouse pointer corresponding to the movement event on the virtual panel.

Step 103: Determine an intersection detection result between the first movement location and the plurality of device screens.

Intersection detection is also known as collision detection. The first device may perform, through a collision manager (CM), detection about whether the first movement location collides with the plurality of device screens, and determine whether the first movement location intersects with any device screen, namely whether a ray where the plurality of movement point coordinates included in the first movement location are located overlaps with a spatial location of any device screen in the virtual panel. The intersection detection result is obtained through detection.

Specifically, after determining, in response to the movement of the mouse, the first movement location of the first mouse pointer on the virtual panel, the first device may detect whether the first movement location intersects with the plurality of device screens and determine the intersection detection result. Specifically, the intersection detection may be respectively performed on the first movement location and the device screens. If the first movement location intersects with a target device screen from the plurality of device screens, the intersection detection result is the target device screen intersecting with the first movement location. If the first movement location does not intersect with the plurality of device screens, the intersection detection result indicates that there is no device screen intersecting with the first movement location. The above target device screen refers to a device screen that intersects with the first movement location among the plurality of device screens. The intersection detection may be achieved through the collision manager, and a specific method is not elaborated herein.

Step 104: Perform movement control on the first mouse pointer and/or a plurality of second mouse pointers of the plurality of second devices based on the intersection detection result, where the first mouse pointer and the second mouse pointers are mutually exclusive in display.

The second mouse pointer may be a simulated mouse pointer in the second device, which may be constructed specifically through a virtual mouse module. Since the second device is not connected with a mouse, it is necessary to represent a mouse movement through the simulated second mouse pointer. The first mouse pointer and the second mouse pointer are mutually exclusive in display. That is, when the first mouse pointer is displayed, the second mouse pointer is hidden, and when the first mouse pointer is hidden, the second mouse pointer is displayed, thereby achieving an effect that only one mouse pointer is displayed on the first device at the same time.

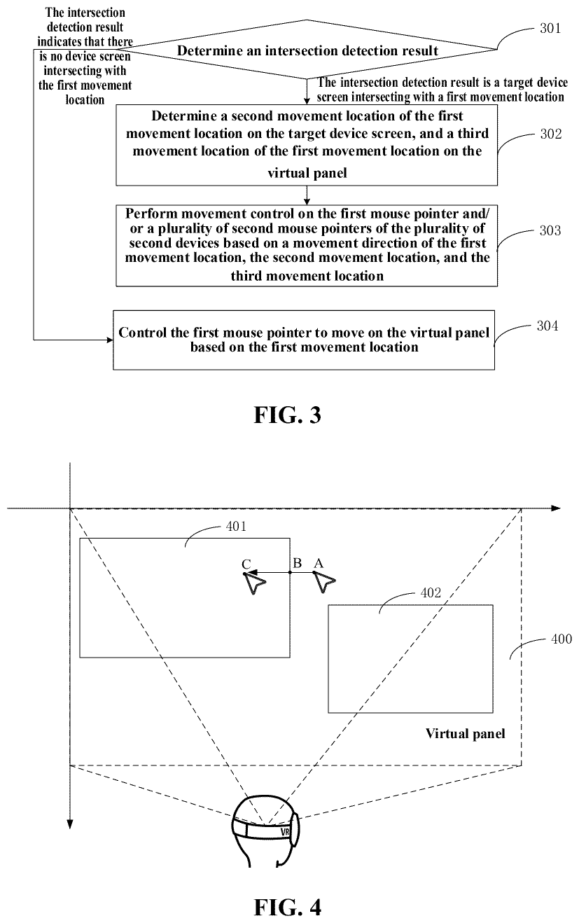

Exemplarily, FIG. 3 is a schematic flowchart of another multi-device mouse control method according to an embodiment of the present disclosure. As shown in FIG. 3, in a feasible implementation, step 104 may include the following steps:

Step 301: Determine an intersection detection result, where if the intersection detection result is a target device screen intersecting with the first movement location, perform step 302; and if the intersection detection result indicates that there is no device screen intersecting with the first movement location, perform step 304.

The target device screen refers to a device screen that intersects with the first movement location among the plurality of device screens.

Step 302: Determine a second movement location of the first movement location on the target device screen, and a third movement location of the first movement location on the virtual panel.

Since the first movement location may include the plurality of movement point coordinates of the first mouse pointer in the process of moving on the virtual panel, the second movement location may be obtained after converting movement point coordinates, overlapping with the target device screen, of the plurality of movement point coordinates included in the first movement location to a second coordinate system of the target device screen from a first coordinate system of the virtual panel. The second movement location may also include a plurality of movement point coordinates. In this case, the second movement location includes a plurality of movement point coordinates from coordinates of an intersection point between a movement trajectory corresponding to the first movement location and the target device screen to coordinates of an end point of the movement trajectory. The third movement location may include a plurality of movement point coordinates, that are located on the virtual panel but not overlap with the target device screen, from the plurality of movement point coordinates included in the first movement location.

After determining the target device screen intersecting with the first movement location, the first device may convert the plurality of movement point coordinates in the first movement location that overlap with the target device screen from the first coordinate system of the virtual panel to the second coordinate system of the target device screen, where an origin of the first coordinate system is different from an origin of the second coordinate system, thereby obtaining the second movement location; and a plurality of movement point coordinates of the first movement location only on the virtual panel are extracted to obtain the third movement location.

Step 303: Perform movement control on the first mouse pointer and/or the plurality of second mouse pointers of the plurality of second devices based on a movement direction of the first movement location, the second movement location, and the third movement location.

The movement direction of the first movement location may include moving from the virtual panel into the target device screen, or moving from the target device screen to the virtual panel.

In some embodiments, the performing movement control on the first mouse pointer and/or the plurality of second mouse pointers of the plurality of second devices based on a movement direction of the first movement location, the second movement location, and the third movement location may include: controlling, based on the third movement location, the first mouse pointer to move on the virtual panel when the movement direction of the first movement location is from the virtual panel to the target device screen; hiding the first mouse pointer when a movement process corresponding to the third movement location is ended, and sending the second movement location to a target device corresponding to the target device screen, such that the target device controls, based on the second movement location, the second mouse pointer to move, and returns a movement screen of the second mouse pointer to the first device; and updating the target device screen to the movement screen of the second mouse pointer on the virtual panel.

The target device may be the second device corresponding to the target device screen among the plurality of second devices.

When the movement direction of the first movement location is from the virtual panel to the target device screen, the first device may first control, based on the third movement location, the first mouse pointer to move on the virtual panel; after the movement process corresponding to the third movement location is ended, the first mouse pointer may be hidden in the virtual panel, and an event dispatcher (ED) in the remote screen proxy sends the second movement location to the target device corresponding to the target device screen; after the virtual mouse module in the target device receives the second movement location, a real mouse may be simulated, the second movement location is reported to the operating system, and the operating system controls the second mouse pointer to move from coordinates of the second movement location before the movement to coordinates after the movement, records a movement screen of the second mouse pointer, and sends the movement screen of the second mouse pointer back to the first device through the streaming technology or the screen casting technology; and after receiving the movement screen of the second mouse pointer sent by the target device, the first device may replace the previous target device screen with the movement screen of the second mouse pointer, and since the first mouse pointer of the virtual panel is hidden, the movement of the mouse from the virtual panel to the target device screen is achieved.

In some other embodiments, the performing movement control on the first mouse pointer and/or the plurality of second mouse pointers of the plurality of second devices based on a movement direction of the first movement location, the second movement location, and the third movement location may include: sending the second movement location to the target device corresponding to the target device screen when the movement direction of the first movement location is from the target device screen to the virtual panel, such that the target device controls, based on the second movement location, the second mouse pointer to move, returns the movement screen of the second mouse pointer to the first device, and updates the target device screen to the movement screen of the second mouse pointer on the virtual plane; and sending a hiding instruction to the target device when the movement process corresponding to the second movement location is ended, such that the target device hides the second mouse pointer, and controls, based on the third movement location, the first mouse pointer to display and move on the virtual panel.

When the movement direction of the first movement location is from the target device screen to the virtual panel, the first device first sends the second movement location to the target device, so as to achieve the movement control on the second mouse pointer of the target device. For a specific process, reference is made to the above embodiment, which will not be repeated herein. When the movement process corresponding to the second movement location is ended, the hiding instruction may be sent to the target device. The target device may hide the corresponding second mouse pointer. In this case, the first device continues to control, based on the third movement location, the first mouse pointer to display and move on the virtual panel, thereby achieving the movement of the mouse from the target device to the virtual panel.

In the above solution, through data interaction between the first device and the plurality of second devices, when the movement location of the first mouse pointer intersects with a screen of a certain device, the movement location on the device screen may be sent to the device, such that the device displays and moves the second mouse pointer, and after the movement, the movement screen is fed back to the first device to be displayed, thereby achieving cyclic switchover of the mouse connected with the first device between the first device and the plurality of second devices. Meanwhile, through exclusive display of the mouse pointers in the different devices, the mouse of the first device and the mice of the plurality of second devices are kept synchronous, where the synchronization herein means that the user may control the mouse pointer of the second device through the mouse of the first device, such that the first device and the plurality of second devices are used as a whole, with the mouse pointers moving along with the mouse.

Step 304: Control the first mouse pointer to move on the virtual panel based on the first movement location.

If the intersection detection result indicates that there is no device screen intersecting with the first movement location, the first device may control, based on the first movement location, the first mouse pointer to move from coordinates of the first movement location before the movement to coordinates after the movement, such that the first mouse pointer on the virtual panel moves along with the mouse. In this case, the mouse hiding instruction is sent to all the second devices through the event dispatcher, such that the second mouse pointers in the device screens of all the second devices in the virtual panel are hidden.

Exemplarily, referring to FIG. 2, an input device in the figure is a mouse. The mouse is connected with the first device. The mouse reports the movement event to the spatial manager of the first device. The spatial manager may determine the first movement location of the first mouse pointer on the virtual panel, performs the intersection detection on the first movement location and the plurality of device screens through the collision manager, and determines the intersection detection result. If the intersection detection result is the target device screen intersecting with the first movement location, the second movement location of the first movement location on the target device screen may be determined, a mouse event carrying the second movement location is sent to the event dispatcher, the event dispatcher may send, through an input connection, the second movement location to the target device corresponding to the target device screen, the target device controls, based on the second movement location, the second mouse pointer to move, the movement screen of the second mouse pointer is returned to the first device, the first device updates the target device screen to the movement screen of the second mouse pointer, and in this case, the first mouse pointer is hidden, and the mouse moves to the target device screen from the virtual panel.

Exemplarily, FIG. 4 is a schematic diagram of a multi-device mouse control according to an embodiment of the present disclosure. As shown in FIG. 4, a virtual panel 400 in the first device is displayed in the figure. The virtual panel 400 may include two device screens of two second devices, such as a device screen 401 and a device screen 402 in the figure. In the figure, the locations of the two device screens on the virtual panel 400 are for illustration only. When the movement trajectory of the first mouse pointer corresponding to the mouse movement on the virtual panel is from a point A to a point C in the figure, the first movement location includes a plurality of movement point coordinates from the point A to the point C. Since the first movement location intersects with the device screen 401, the device screen 401 is the target device screen, and the movement direction is from the virtual panel to the target device screen. The second movement location of the first movement location on the device screen 401 and the third movement location of the first movement location on the virtual panel are determined, the second movement location includes coordinates of an intersection point between the movement trajectory corresponding to the first movement location and the target device screen, namely a plurality of movement point coordinates from a point B to the point C in the figure, and the third movement location includes a plurality of movement point coordinates from the point A to the point B. After the first mouse pointer is controlled to move from the point A to the point B on the virtual panel based on the third movement location, the first mouse pointer is hidden, the second movement pointer in the target device moves from the point B to the point C as well, and after the virtual panel updates the target device screen to the movement screen of the second mouse pointer, one mouse pointer is controlled to move from the point A to the point C from the perspective of the user.

It should be understood that the input device being the mouse is used as an example in this embodiment of the present disclosure, and the input device may also include a keyboard, or a joystick, or the like, and the method of the solution may be adopted to implement the operation of the first device and the plurality of second devices through one input device.

According to the multi-device mouse control solution provided by this embodiment of the present disclosure, the first device based on the virtual reality technology displays the plurality of device screens of the plurality of second devices on the virtual panel; in response to the movement of the mouse, the first movement location of the first mouse pointer on the virtual panel is determined, where the mouse is connected with the first device; the intersection detection result between the first movement location and the plurality of device screens is determined; and the movement control is performed on the first mouse pointer and/or the plurality of second mouse pointers of the plurality of second devices based on the intersection detection result, where the first mouse pointer and the second mouse pointers are mutually exclusive in display. By adopting the above technical solution, on the basis of displaying the plurality of device screens of the plurality of second devices on the virtual panel of the first device, the first movement location of the first mouse pointer on the virtual panel may be determined when the mouse moves, and the movement control is performed on the first mouse pointer and/or the second mouse pointers of the plurality of second devices based on the intersection detection result between the first movement location and the plurality of device screens; and based on the intersection detection on the mouse movement location and the plurality of device screens, as well as the mutually exclusive display setting of the mouse pointers of the first device and the other devices, the first device and the plurality of second devices displaying the device screens in the first device may be rapidly operated with one mouse, thereby avoiding the operation of the plurality of mice, and improving operation efficiency.

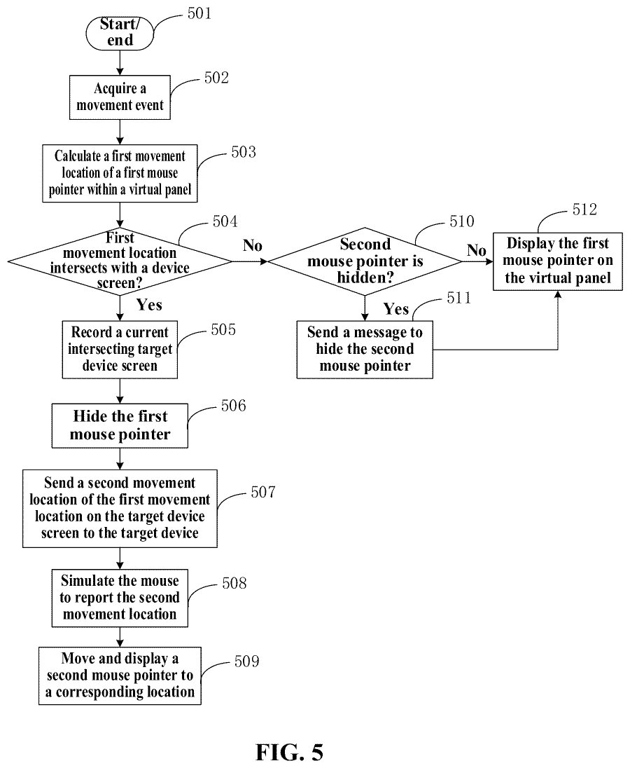

The multi-device mouse control solution in this embodiment of the present disclosure is further described in conjunction with a specific example below. Exemplarily, FIG. 5 is a schematic flowchart of yet another multi-device mouse control method according to an embodiment of the present disclosure. As shown in FIG. 5, with a movement direction from the virtual panel to the target device screen as an example in the figure, the multi-device mouse control process may include step 501: Start/end. Step 502: Acquire a movement event reported by a mouse. Step 503: Calculate, by a spatial manager, a first movement location of a first mouse pointer within a virtual panel. Step 504: Determine whether the first movement location intersects with a device screen of a second device, where if yes, perform step 505; and if not, perform step 510. Step 505: Record a current intersecting target device screen. Step 506: Hide the first mouse pointer. Step 507: Send, by an event dispatcher, a second movement location of the first movement location on the target device screen to a target device corresponding to the target device screen. The second movement location may be carried in a mouse event to be sent. Step 508: Simulate, by the target device, the mouse to report the second movement location to an operating system. Step 509: Move and display, by the target device, a second mouse pointer to a corresponding location based on the second movement location. That is, the target device controls the movement of the second mouse pointer based on the second movement location and returns a movement screen of the second mouse pointer to a first device. Step 510: Determine whether the second mouse pointer is hidden within a previously intersecting device screen, where if yes, perform step 511; and if not, perform step 512. Step 511: Send a message to a previously intersecting second device to hide the second mouse pointer. The step may ensure that when the mouse leaves the previously intersecting second device, the corresponding second mouse pointer is hidden. Step 512: Display the first mouse pointer on the virtual panel, that is, control the first mouse pointer to move on the virtual panel based on the first movement location.

In the solution, one input device (the mouse) may be used to operate the plurality of other devices displayed in the head mounted display. Additionally, through the mutually exclusive display of the mouse pointers of the head mounted display and the other devices, a single mouse is cyclically switched between the plurality of other devices, thereby keeping the mice on the head mounted display and the other devices synchronized.

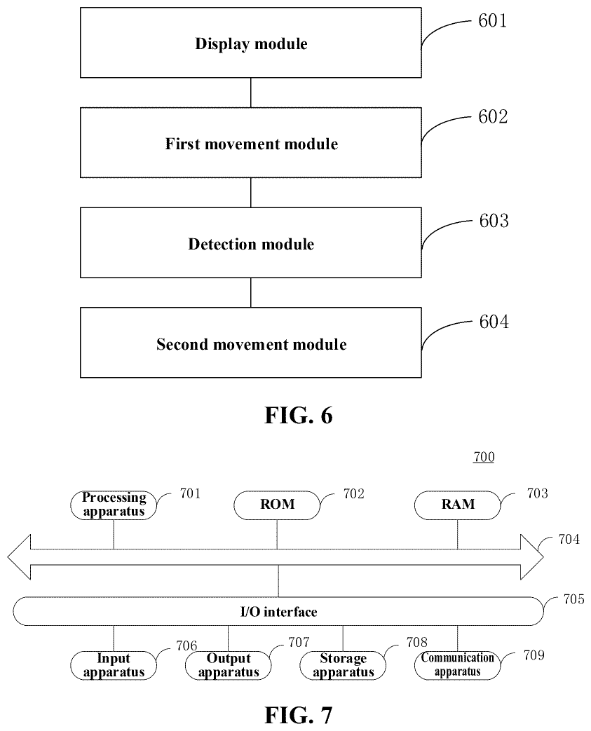

FIG. 6 is a structural schematic diagram of a multi-device mouse control apparatus according to an embodiment of the present disclosure. The apparatus may be implemented by software and/or hardware, and may be typically integrated in an electronic device. As shown in FIG. 6, the apparatus is arranged on a first device based on a virtual reality technology, and includes:
a display module 601, configured to display a plurality of device screens of a plurality of second devices on a virtual panel;
a first movement module 602, configured to determine, in response to a movement of a mouse, a first movement location of a first mouse pointer on the virtual panel, where the mouse is connected with the first device;
a detection module 603, configured to determine an intersection detection result between the first movement location and the plurality of device screens; and
a second movement module 604, configured to perform movement control on the first mouse pointer and/or a plurality of second mouse pointers of the plurality of second devices based on the intersection detection result, where the first mouse pointer and the second mouse pointers are mutually exclusive in display.

Optionally, the display module 601 is configured to:
create the virtual panel in a virtual space through a screen manager; and
display the plurality of device screens of the plurality of second devices on the virtual panel through a streaming technology or a screen casting technology.

Optionally, the detection module 603 is configured to:
respectively perform intersection detection on the first movement location and the device screens, where if the first movement location intersects with a target device screen of the plurality of device screens, the intersection detection result is the target device screen intersecting with the first movement location; and
if the first movement location does not intersect with the plurality of device screens, the intersection detection result indicates that there is no device screen intersecting with the first movement location.

Optionally, the second movement module 604 includes:
a first unit, configured to determine a second movement location of the first movement location on the target device screen, and a third movement location of movement location on the virtual panel if the intersection detection result is the target device screen intersecting with the first movement location; and
a second unit, configured to perform movement control on the first mouse pointer and/or the plurality of second mouse pointers of the plurality of second devices based on a movement direction of the first movement location, the second movement location, and the third movement location.

Optionally, the second unit is configured to:
control the first mouse pointer to move on the virtual panel based on the third movement location if the movement direction of the first movement location is from the virtual panel to the target device screen;
hide the first mouse pointer when a movement process corresponding to the third movement location is ended, and send the second movement location to a target device corresponding to the target device screen, such that the target device controls, based on the second movement location, the second mouse pointer to move, and returns a movement screen of the second mouse pointer to the first device; and
update the target device screen to the movement screen of the second mouse pointer on the virtual panel.

Optionally, the second unit is configured to:
send the second movement location to a target device corresponding to the target device screen when the movement direction of the first movement location is from the target device screen to the virtual panel, such that the target device controls, based on the second movement location, the second mouse pointer to move, returns the movement screen of the second mouse pointer to the first device, and updates the target device screen to the movement screen of the second mouse pointer on the virtual plane; and
send a hiding instruction to the target device when a movement process corresponding to the second movement location is ended, such that the target device hides the second mouse pointer, and controls, based on the third movement location, the first mouse pointer to display and move on the virtual panel.

Optionally, the second movement module 604 is further configured to:
control, based on the first movement location, the first mouse pointer to move on the virtual panel if the intersection detection result indicates that there is no device screen intersecting with the first movement location.

Optionally, the first device is a virtual reality head mounted display.

The multi-device mouse control apparatus provided by this embodiment of the present disclosure may perform the multi-device mouse control method provided by any embodiment of the present disclosure, and has the corresponding functional modules and beneficial effects for performing the method.

An embodiment of the present disclosure further provides a computer program product including computer programs/instructions. The computer programs/instructions, when executed by a processor, implement the multi-device mouse control method provided by any embodiment of the present disclosure.

FIG. 7 is a structural schematic diagram of an electronic device according to an embodiment of the present disclosure.

Specifically referring to FIG. 7 below, FIG. 7 is a structural schematic diagram of an electronic device 700 suitable for implementing an embodiment of the present disclosure. The electronic device 700 in this embodiment of the present disclosure may include, but is not limited to, mobile terminals such as a mobile phone, a notebook computer, a digital radio receiver, a personal digital assistant (PDA), a portable Android device (PAD), a portable media player (PMP), and a vehicle-mounted terminal (e.g., a vehicle-mounted navigation terminal), and fixed terminals such as a digital TV and a desktop computer. The electronic device shown in FIG. 7 is merely an example and should not impose any limitations on the functionality and scope of use of this embodiment of the present disclosure.

As shown in FIG. 7, the electronic device 700 may include a processing apparatus (e.g., a central processing unit and a graphics processing unit) 701 that may perform various suitable actions and processes based on a program stored in a read-only memory (ROM) 702 or a program loaded from a storage apparatus 708 into a random access memory (RAM) 703. The RAM 703 further stores various programs and data required for the operation of the electronic device 700. The processing apparatus 701, the ROM 702, and the RAM 703 are connected to one another through a bus 704. An input/output (I/O) interface 705 is also connected to the bus 704.

Typically, the following apparatuses may be connected to the I/O interface 705: an input apparatus 706 including, for example, a touch screen, a touch pad, a keyboard, a mouse, a camera, a microphone, an accelerometer, and a gyroscope; an output apparatus 707 including, for example, a liquid crystal display (LCD), a speaker, and a vibrator; the storage apparatus 708 including, for example, a magnetic tape and a hard drive; and a communication apparatus 709. The communication apparatus 709 may allow the electronic device 700 to be in wireless or wired communication with other devices for data exchange. Although FIG. 7 illustrates the electronic device 700 with various apparatuses, it should be understood that it is not necessary to implement or have all the shown apparatuses. It may be an alternative to implement or have more or fewer apparatuses.

Particularly, the foregoing process described with reference to the flowcharts according to the embodiments of the present disclosure may be implemented as a computer software program. For example, an embodiment of the present disclosure includes a computer program product, which includes a computer program carried on a non-transitory computer-readable medium, where the computer program includes program code used to perform the method shown in the flowchart. In this embodiment, the computer program may be downloaded and installed from the network through the communication apparatus 709, or installed from the storage apparatus 708, or installed from the ROM 702. The computer program, when executed by the processing apparatus 701, performs the above functions defined in the multi-device mouse control method in the embodiments of the present disclosure.

It should be noted that the computer-readable medium in the present disclosure may be either a computer-readable signal medium or a computer-readable storage medium, or any combination of the two. The computer-readable storage medium may be, for example, but is not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination of the above. In the present disclosure, the computer-readable storage medium may be any tangible medium including or storing a program, and the program may be used by or in conjunction with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program for use by or for use in conjunction with the instruction execution system, apparatus, or device. The program code included in the computer-readable medium may be transmitted by any suitable medium including but not limited to a wire, an optical cable, radio frequency (RF), etc., or any suitable combination of the above.

In some implementations, a client and a server may communicate using any currently known or future-developed network protocols such as a hypertext transfer protocol (HTTP), and may be interconnected with digital data communication in any form or medium (e.g., a communication network). Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The computer-readable medium may be included in the above electronic device; or may also separately exist without being assembled in the electronic device.

The computer-readable medium carries one or more programs. The one or more programs, when executed by the electronic device, cause the electronic device to: display a plurality of device screens of a plurality of second devices on a virtual panel; determine, in response to a movement of a mouse, a first movement location of a first mouse pointer on the virtual panel, where the mouse is connected with the first device; determine an intersection detection result between the first movement location and the plurality of device screens; and perform movement control on the first mouse pointer and/or a plurality of second mouse pointers of the plurality of second devices based on the intersection detection result, where the first mouse pointer and the second mouse pointers are mutually exclusive in display.

Computer program code for performing operations of the present disclosure may be written in one or more programming languages or a combination thereof, where the programming languages include, but are not limited to, object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a local area network (LAN) or a wide area network (WAN), or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code includes one or more executable instructions for implementing specified logic functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on functions involved. It should also be noted that each block in the block diagrams and/or the flowcharts, and a combination of the blocks in the block diagrams and/or the flowcharts may be implemented by using a dedicated hardware-based system that performs specified functions or operations, or may be implemented by using a combination of dedicated hardware and computer instructions.

The related units described in the embodiments of the present disclosure may be implemented by software or hardware. The name of the unit does not limit the unit in certain cases.

Herein, the functions described above may be at least partially executed by one or more hardware logic components. For example, without limitation, exemplary hardware logic components that can be used include: a field-programmable gate array (FPGA), an application specific integrated circuit (ASIC), an application specific standard part (ASSP), a system on chip (SOC), a complex programmable logic device (CPLD), etc.

In the context of the present disclosure, a machine-readable medium may be a tangible medium that may include or store a program for use by or for use in conjunction with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above content.

It should be understood that before the use of the technical solutions disclosed in the embodiments of the present disclosure, the user shall be informed of the type, range of use, use scenarios, etc., of information involved in the present disclosure in an appropriate manner in accordance with the relevant laws and regulations, and the authorization of the user shall be obtained.

What are described above are only preferred embodiments of the present disclosure and explanations of the technical principles applied. Those skilled in the art should understand that the scope of the disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure, such as a technical solution formed by replacing the foregoing features with the technical features with similar functions disclosed (but not limited to) in the present disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the present disclosure. Some features that are described in the context of separate embodiments may also be implemented in combination in a single embodiment. In contrast, various features described in the context of a single embodiment may also be implemented in a plurality of embodiments separately or in any suitable sub-combination.

Although the subject matter has been described in a language specific to structural features and/or logic actions of the method, it should be understood that the subject matter defined in the appended claims is not necessarily limited to the specific features or actions described above. On the contrary, the specific features and the actions described above are merely example forms for implementing the claims.

I/We claim:

1. A method for multi-device mouse control, applied to a first device based on a virtual reality technology, comprising:
displaying a plurality of device screens of a plurality of second devices on a virtual panel;
determining, in response to a movement of a mouse, a first movement location of a first mouse pointer on the virtual panel, wherein the mouse is connected with the first device;
determining an intersection detection result between the first movement location and the plurality of device screens; and
performing movement control on the first mouse pointer and/or a plurality of second mouse pointers of the plurality of second devices based on the intersection detection result, wherein the first mouse pointer and the second mouse pointers are mutually exclusive in display.

2. The method according to claim 1, wherein displaying the plurality of device screens of the plurality of second devices on the virtual panel comprises:
creating the virtual panel in a virtual space by a screen manager; and
displaying the plurality of device screens of the plurality of second devices on the virtual panel through a streaming technology or a screen casting technology.

3. The method according to claim 1, wherein determining the intersection detection result between the first movement location and the plurality of device screens comprises:
performing intersection detection between the first movement location and each of the device screens respectively, wherein in response to the first movement location intersecting with a target device screen of the plurality of device screens, the intersection detection result is the target device screen intersecting with the first movement location; and
in response to the first movement location not intersecting with the plurality of device screens, the intersection detection result is that no device screen intersects with the first movement location.

4. The method according to claim 3, wherein performing movement control on the first mouse pointer and/or the plurality of second mouse pointers of the plurality of second devices based on the intersection detection result comprises:
in response to the intersection detection result being the target device screen intersecting with the first movement location, determining a second movement location of the first movement location on the target device screen and a third movement location of the first movement location on the virtual panel; and
performing movement control on the first mouse pointer and/or the plurality of second mouse pointers of the plurality of second devices based on a movement direction of the first movement location, the second movement location, and the third movement location.

5. The method according to claim 4, wherein performing movement control on the first mouse pointer and/or the plurality of second mouse pointers of the plurality of second devices based on the movement direction of the first movement location, the second movement location, and the third movement location comprises:
in response to the movement direction of the first movement location being from the virtual panel to the target device screen, controlling the first mouse pointer to move on the virtual panel based on the third movement location;
in response to a movement process corresponding to the third movement location being ended, hiding the first mouse pointer, and sending the second movement location to a target device corresponding to the target device screen, such that the target device controls, based on the second movement location, the second mouse pointer to move, and returns a movement screen of the second mouse pointer to the first device; and
updating the target device screen to the movement screen of the second mouse pointer on the virtual panel.

6. The method according to claim 4, wherein performing movement control on the first mouse pointer and/or the plurality of second mouse pointers of the plurality of second devices based on the movement direction of the first movement location, the second movement location, and the third movement location comprises:
in response to the movement direction of the first movement location being from the target device screen to the virtual panel, sending the second movement location to a target device corresponding to the target device screen, such that the target device controls, based on the second movement location, the second mouse pointer to move, returns a movement screen of the second mouse pointer to the first device, and updating the target device screen to the movement screen of the second mouse pointer on the virtual plane; and
in response to a movement process corresponding to the second movement location being ended, sending a hiding instruction to the target device, such that the target device hides the second mouse pointer, and controls, based on the third movement location, the first mouse pointer to display and move on the virtual panel.

7. The method according to claim 3, wherein performing control on the first mouse pointer and/or the plurality of second mouse pointers of the plurality of second devices based on the intersection detection result comprises:
in response to the intersection detection result being that no device screen intersects with the first movement location, controlling, based on the first movement location, the first mouse pointer to move on the virtual panel.

8. The method according to claim 1, wherein the first device is a virtual reality head mounted display.

9. An electronic device, wherein the electronic device comprises:
a processor; and
a memory configured to store executable instructions of the processor, wherein the processor is configured to read the executable instructions from the memory, and the instructions, when executed by the processor, cause the electronic device to:
display a plurality of device screens of a plurality of second devices on a virtual panel;
determine, in response to a movement of a mouse, a first movement location of a first mouse pointer on the virtual panel, wherein the mouse is connected with the first device;
determine an intersection detection result between the first movement location and the plurality of device screens; and
perform movement control on the first mouse pointer and/or a plurality of second mouse pointers of the plurality of second devices based on the intersection detection result, wherein the first mouse pointer and the second mouse pointers are mutually exclusive in display.

10. The electronic device according to claim 9, wherein the instructions causing the electronic device to display the plurality of device screens of the plurality of second devices on the virtual panel further cause the electronic device to:
create the virtual panel in a virtual space by a screen manager; and
display the plurality of device screens of the plurality of second devices on the virtual panel through a streaming technology or a screen casting technology.

11. The electronic device according to claim 9, wherein the instructions causing the electronic device to determine the intersection detection result between the first movement location and the plurality of device screens further cause the electronic device to:
perform intersection detection between the first movement location and each of the device screens respectively, wherein in response to the first movement location intersecting with a target device screen of the plurality of device screens, the intersection detection result is the target device screen intersecting with the first movement location; and
in response to the first movement location not intersecting with the plurality of device screens, the intersection detection result is that no device screen intersects with the first movement location.

12. The electronic device according to claim 11, wherein the instructions causing the electronic device to perform movement control on the first mouse pointer and/or the plurality of second mouse pointers of the plurality of second devices based on the intersection detection result further cause the electronic device to:
in response to the intersection detection result being the target device screen intersecting with the first movement location, determine a second movement location of the first movement location on the target device screen and a third movement location of the first movement location on the virtual panel; and
perform movement control on the first mouse pointer and/or the plurality of second mouse pointers of the plurality of second devices based on a movement direction of the first movement location, the second movement location, and the third movement location.

13. The electronic device according to claim 12, wherein the instructions causing the electronic device to perform movement control on the first mouse pointer and/or the plurality of second mouse pointers of the plurality of second devices based on the movement direction of the first movement location, the second movement location, and the third movement location further cause the electronic device to:
in response to the movement direction of the first movement location being from the virtual panel to the target device screen, control the first mouse pointer to move on the virtual panel based on the third movement location;
in response to a movement process corresponding to the third movement location being ended, hide the first mouse pointer, and send the second movement location to a target device corresponding to the target device screen, such that the target device controls, based on the second movement location, the second mouse pointer to move, and returns a movement screen of the second mouse pointer to the first device; and
update the target device screen to the movement screen of the second mouse pointer on the virtual panel.

14. The electronic device according to claim 12, wherein the instructions causing the electronic device to perform movement control on the first mouse pointer and/or the plurality of second mouse pointers of the plurality of second devices based on the movement direction of the first movement location, the second movement location, and the third movement location further cause the electronic device to:
in response to the movement direction of the first movement location being from the target device screen to the virtual panel, send the second movement location to a target device corresponding to the target device screen, such that the target device controls, based on the second movement location, the second mouse pointer to move, returns a movement screen of the second mouse pointer to the first device, and update the target device screen to the movement screen of the second mouse pointer on the virtual plane; and
in response to a movement process corresponding to the second movement location being ended, send a hide instruction to the target device, such that the target device hides the second mouse pointer, and controls, based on the third movement location, the first mouse pointer to display and move on the virtual panel.

15. The electronic device according to claim 11, wherein the instructions causing the electronic device to perform control on the first mouse pointer and/or the plurality of second mouse pointers of the plurality of second devices based on the intersection detection result further cause the electronic device to:
in response to the intersection detection result being that no device screen intersects with the first movement location, control, based on the first movement location, the first mouse pointer to move on the virtual panel.

16. The electronic device according to claim 9, wherein the first device is a virtual reality head mounted display.

17. A non-transitory computer-readable storage medium, wherein the storage medium stores a computer program, and the computer program, when executed by a processor, causes the processor to:
display a plurality of device screens of a plurality of second devices on a virtual panel;
determine, in response to a movement of a mouse, a first movement location of a first mouse pointer on the virtual panel, wherein the mouse is connected with the first device;
determine an intersection detection result between the first movement location and the plurality of device screens; and
perform movement control on the first mouse pointer and/or a plurality of second mouse pointers of the plurality of second devices based on the intersection detection result, wherein the first mouse pointer and the second mouse pointers are mutually exclusive in display.

18. The non-transitory computer-readable storage medium according to claim 17, wherein the computer program causing the processor to display the plurality of device screens of the plurality of second devices on the virtual panel further causes the processor to:
create the virtual panel in a virtual space by a screen manager; and
display the plurality of device screens of the plurality of second devices on the virtual panel through a streaming technology or a screen casting technology.

19. The non-transitory computer-readable storage medium according to claim 17, wherein the computer program causing the processor to determine the intersection detection result between the first movement location and the plurality of device screens further causes the processor to:
perform intersection detection between the first movement location and each of the device screens respectively, wherein in response to the first movement location intersecting with a target device screen of the plurality of device screens, the intersection detection result is the target device screen intersecting with the first movement location; and
in response to the first movement location not intersecting with the plurality of device screens, the intersection detection result is that no device screen intersects with the first movement location.

20. The non-transitory computer-readable storage medium according to claim 19, wherein the computer program causing the processor to perform movement control on the first mouse pointer and/or the plurality of second mouse pointers of the plurality of second devices based on the intersection detection result further causes the processor to:
in response to the intersection detection result being the target device screen intersecting with the first movement location, determine a second movement location of the first movement location on the target device screen and a third movement location of the first movement location on the virtual panel; and
perform movement control on the first mouse pointer and/or the plurality of second mouse pointers of the plurality of second devices based on a movement direction of the first movement location, the second movement location, and the third movement location.
